(19) United States
(12) Patent Application Publication
(10) Pub. No.: US 2006/0271376 A1
(43) Pub. Date: Nov. 30, 2006

(54) FastFix - The Cargo Fixture System

(76) Inventor: Vijaya S. Iswara, Brooklyn, NY (US)

Correspondence Address: Vijaya Iswara, 709 Woodland Avenue, Plainfield, NJ, 07062, US

(21) Appl. No.: 10/908,753

(22) Filed: May 25, 2005

(51) Int. Cl. G06Q 99/00

(52) U.S. Cl. 705/1

(57) ABSTRACT

Freight prices agreed between charterers and ship owners, to transport dry, liquid, refrigirated and all other types of bulk commodities, are believed to be the best pricing of shipping asstes specific to a transaction expressed as per metric ton freight rate. The FastFix system offers a comprehensive solution that maintains highest degree of relevance to market forces, cost structures unique to individual shipping organizations, ongoing but ever changing worldiwide supply and demand for tonnage, expectations of commodity traders, shipbrokers and other participants such as international bankers. The system helps traders, charterers and ship owners to fully integrate their disparate processes for the benefit of Planning the shipments, Minimizing the capital blocked in a transaction, Timing the launch of banking instruments such as Letters of Credit, Managing currency risks, production risks, commodity pricing risks, Sourcing ships, Negotiating charterparty terms, Facilitating high levels transperancy of voyage process from beginning to end, Causing efficient deployment and re-deployment of world shipping fleet without compromising commercial interests of any specific segment, Improving and simplifying international trade final delivery system and last but not the least, Resulting in product pricing efficiencies through delivering consistently better landed costs of raw materials to finished goods at whole sale levels.

FastFix system is a comprehensive cargo fixture system designed to assist international traders, shippers of bulk commodities, ship owners, shipbrokers and cargo brokers in arriving at appropriate freight rates agreeable to all parties at any given moment for a specific voyage parcel worldwide.

The system through its various internal processes produces the most reflective shipping asset pricing which also can be called freight rates per metric ton.

What is claimed is:

1. FastFix System Module No. 1 Trade Genie, which consists of Process No. 1, Module No. 2, Module No. 3, Module No. 4, Module No. 5, Module No. 6, Module No. 7 and Module No. 8. FastFix System Trade planner Process No. 1 which consists of process No. 1.1, No. 1.2, No 1.3 and No. 1.4. FastFix System Trade planner Process No. 1.3 which consists of process No. 1.3) 1. Through 1.3) 10. FastFix System Trade planner Process No. 1.3) 1 which consists of Module No. 2 and Module No. 3. FastFix System Trade planner Process No. 1.3) 2 which consists of Module No. 4. FastFix System Trade planner Process No. 1.3) 4 which consists of Module No. 5. FastFix System Trade planner Process No. 1.3) 5 which consists of Module No. 6. FastFix System Trade planner Process No. 1.3) 6 which consists of Module No. 7 and Module No. 8. FastFix System Module No. 2 Databaud, which consists of sub-processes No. 2.1 and No. 2.2. FastFix System Module No. 3 QuoteMaster, which consists of sub-processes No. 3.1, No. 3.2 and No. 3.3. FastFix System Process No. 3.1 comprising 3.1.1, No. 3.2 comprising 3.2.1) and No. 3.3 comprising 3.3.1), 3.3.2), 3.3.3). FastFix System Module No. 4 Lift Consult, which consists of process No. 4.1.1. FastFix System Module No. 5 Ship Scout, which consists of process No. 5.1 comprising items (a) through (j), No. 5.1.1 comprising No. 5.1.1) 1, No 5.2 comprising 5.2.1 comprising of items (a) through (j) and 5.2.1) 1 through 5.2.1) 4, No. 5.3 comprising No. 5.3.1 through 5.3.10. FastFix System Module No. 6 Deal Driver, which consist of process No. 6.1, No. 6.2, 6.3 comprising 6.3.1 and 6.4. FastFix System Module No. 7 Ship Yes, which consist of process No. 7.1. FastFix System Module No. 8 Reports Genie, which consist of process No. 8.1.1 through 8.1.5. FastFix System Process No. 8.1.1 Financial Section which consists of process No. 8.1.1) 1 through 8.1.1) 8, FastFix System Process No. 8.1.2 Cargo Section which consists of process No. 8.1.2) 1, FastFix System Process No. 8.1.3 Technical Section which consists of process No. 8.1.3) 1, No. 8.1.3) 2 comprising 8.1.3) 2.1 which consists of 8.1.3) 2.1.1 and 8.1.3) 2.2 which consists of 8.1.3) 2.2.1, No. 8.1.3) 3 comprising 8.1.3) 3.1 through 8.1.3) 3.3. No. 8.1.3) 4 comprising 8.1.3) 4.1 through 8.1.3) 4.3. FastFix System Process No. 8.1.4 News Section, which consists of process No. 8.1.4) 1 comprising 8.1.4) 1.1 through 8.1.4) 1.3, No. 8.1.4) 2 comprising 8.1.4) 2.1, and No. 8.1.4) 3. FastFix System process No. 8.1.5 Documents Section which consists of process No. 8.1.5) 1 through process No. 8.1.5) 4. FastFix System Process No. 8.1.5) 1 Sellers Documentation which consists of items No. 8.1.5) 1.1 through No. 8.1.5) 1.13. FastFix System Process No. 8.1.5) 2 Buyers Documentation which consists of items No. 8.1.5) 2.1 through No. 8.1.5) 2.6. FastFix System Process No. 8.1.5) 3 FastFix Documentation which consists of items No. 8.1.5) 3.1 through No. 8.1.5) 3.4. FastFix System Process No. 8.1.5) 4 Ship Owners Documentation which consists of items No. 8.1.5) 4.1 through No. 8.1.5) 4.5.
